(19) United States
(12) Patent Application Publication
(10) Pub. No.: US 2011/0165689 A1
(43) Pub. Date: Jul. 7, 2011

(54) METHODS, COMPOSITIONS, AND ARTICLES COMPRISING STABILIZED GOLD NANOCLUSTERS

(75) Inventors: Jackie Y. Ying, Singapore (SG); Jianping Xie, Singapore (SG); Yuangang Zheng, Singapore (SG)

(73) Assignee: AGENCY FOR SCIENCE, TECHNOLOGY AND RESEARCH 1 FUSIONOPLIS WAY

(21) Appl. No.: 13/057,640

(22) PCT Filed: Aug. 4, 2009
(86) PCT No.: PCT/SG09/00272

§ 371 Date: Feb. 4, 2011

(30) Foreign Application Priority Data
Aug. 5, 2008 (US) 61129994

(51) Int. Cl. G01N 21/64; C09K 11/02

(52) U.S. Cl. 436/81; 252/301.36

(57) ABSTRACT

The invention relates generally to gold nanoclusters, and in particular, fluorescent gold nanoclusters. The gold nanoclusters may be stabilized, for example, with a protein or stabilizing agent. In some cases, the gold nanoclusters may be used in methods or articles to determine the presence, absence, and/or concentration of mercuric ions in a sample.

### RELATED APPLICATIONS

This application claims priority under 35 U.S.C. §119(e) to co-pending U.S. Provisional Application Ser. No. 61/129,994, filed Aug. 5, 2008, the contents of which are incorporated herein by reference.

### FIELD OF THE INVENTION

The invention relates generally to gold nanoclusters, and in particular, fluorescent gold nanoclusters. The gold nanoclusters may be stabilized, for example, with a protein or stabilizing agent. In some cases, the gold nanoclusters may be used in methods or articles to determine the presence, absence, and/or concentration of mercuric ions in a sample.

### BACKGROUND OF THE INVENTION

Noble metal nanoclusters (NCs) typically comprise of several to tens of metal atoms and are generally less than 1 nm in size. The spatial confinement of free electrons in metal nanoclusters may result in discrete and size-tunable electronic transitions, leading to molecular-like properties such as luminescence and unique charging properties. In contrast to semiconductor quantum dots (QDs), which are larger in dimensions (e.g., approximately 3 to 100 nm) and may contain toxic metal species (e.g., cadmium, lead), noble metal nanoclusters are attractive for various applications (e.g., sensing) due to their ultrafine size and non-toxicity. It is of interest to develop methods and techniques for the synthesis of fluorescent gold nanoclusters with red or near-infrared emissions, which could be used in many applications, for example, for the detection of mercuric ions.

Routine detection of mercuric ions (Hg²⁺) is central to environmental monitoring in aquatic ecosystems because of its deleterious effects on the environment and human health. In the past few years, several optical sensor systems for the detection of mercuric ions have been developed based on small organic molecules (fluorophores or chromophores), biomolecules (proteins, antibodies, oligonucleotides, DNAzymes, etc.), and various materials (polymeric or inorganic). Many of these systems, however, are constrained with respect to simplicity, sensitivity, selectivity, and/or limited in practical applications (e.g., incompatible with aqueous environment).

Accordingly, improved methods and materials are needed.

### SUMMARY OF THE INVENTION

In some embodiments, the present invention provides compositions. In a first embodiment, a composition comprises a plurality of gold nanoclusters, and a protein or stabilizing agent, wherein the gold nano clusters are capable of emitting fluorescence at a wavelength between about 630 nm and about 700 nm with a quantum yield of at least 1%.

In some embodiments, the present invention provides methods. According to a first embodiment, a method for forming a plurality of gold nanoclusters comprises forming a reaction mixture comprising a plurality of molecules of gold atom precursor and plurality of molecules of protein, wherein the ratio of molecules of gold atom precursor to molecules of protein is at least about 5:1, adjusting the pH of the reaction mixture to be greater than about 11, and maintaining the reaction mixture at a suitable temperature for a sufficient period of time to form a plurality of gold nanoclusters stabilized by at least one protein molecule, wherein the gold nano clusters have an average diameter of less than about 2 nm.

In another embodiment, a method of detecting mercuric ions comprises providing a composition comprising a plurality of gold nanoclusters and a protein or a stabilizing agent, exposing the composition to a sample suspected of containing mercuric ions, and determining whether the sample comprises mercuric ions. In yet another embodiment, a method of detecting mercuric ions comprises providing a plurality of gold nanoclusters, the gold nanoclusters having a first fluorescent intensity at a wavelength between about 630 nm and about 700 nm with a quantum yield of at least 1%, exposing the nanoclusters to a sample suspected of containing mercuric ions and determining a change in the fluorescent intensity, and determining whether the sample contains mercuric ions based upon the change in the fluorescent intensity.

In some cases, a method of detecting mercuric ions comprises providing a composition comprising a plurality of stabilized gold nanoclusters having the formula Au₂₅, exposing the composition to a sample suspected of containing mercuric ions, and determining whether the sample comprises mercuric ions.

In some embodiments, the present invention provides articles. In some cases, an article for determining the presence or absence of mercuric ions in a sample comprises a substrate, and a composition associated with the substrate, wherein the composition comprises gold nanoclusters and a protein or a stabilizing agent.

### BRIEF DESCRIPTION OF THE DRAWINGS

FIG. 1 shows a schematic of the formation of gold nanoclusters associated with bovine serum albumin (BSA-Au-NCs), according to a non-limiting embodiment of the invention.

FIG. 2A shows photographs of BSA (1) powder and (2) aqueous solution, and BSA-Au-NCs (3) aqueous solution and (4) powder under (top) visible and (bottom) UV light, according to one embodiment.

FIG. 2B shows the optical absorption (dash lines) and photoemission (solid lines, λₑₓ=470 nm) spectra of aqueous solution of (i) BSA and (ii) BSA-Au-NCs. The inset shows the weak absorption peak at about 480 nm for BSA-Au-NCs.

FIG. 3 shows time evolution of photoemission spectra (λₑₓ=470 nm) for a reaction mixture comprising HAuCl₄ and BSA at 37° C., according to a non-limiting embodiment.

FIG. 4 shows (A) XPS spectra of Au 4f in (iii) BSA-Au-NCs and (B) MALDI-TOF mass spectra of (iv) BSA and (v) BSA-Au-NCs.

FIG. 4C shows the TGA analysis of BSA-Au-NC powder in air, according to a non-limiting embodiment.

FIG. 5 shows representative TEM images of BSA-Au-NCs.

FIG. 6 shows (A) DLS histograms, (B) Fourier-transform infrared (FTIR) spectra, (C) zeta potential results, and (D) far-UV circular dichroism (CD) spectra of (i, or black) BSA and (ii, or grey) BSA-Au-NCs, according to non-limiting embodiments. The inset in (A) shows the electrophoresis data (under UV light) of (ii) BSA (conjugated with FITC dye) and (i) BSA-Au-NCs.

FIG. 7 shows photographs under (A) visible and (B) ultraviolet light, (C) optical absorption spectra, and (D) photoemission spectra (λₑₓ=470 nm) for (0) BSA, (1) BSA-Au-NCs synthesized under optimized conditions, (2) BSA-Au-NCs synthesized with NaBH₄, (3) BSA-Au-NCs synthesized without NaOH, (4) BSA-Au-NCs synthesized at 100° C., and (5) BSA-Au-NCs synthesized with a low BSA concentration.

FIG. 8 shows a representative TEM image of BSA-Au-NCs synthesized without NaOH.

FIG. 9 shows (A) photoemission spectra (λₑₓ=470 nm), and (B) photographs under UV light of BSA-Au-NCs (20 mM) in the (1) absence and (2) presence of Hg²⁺ ions (50 mM), and (C) a schematic of Hg²⁺ sensing based on the fluorescence quenching of BSA-Au-NCs.

FIG. 10 shows XPS Hg 4f spectra of (A) Hg ions sequestered by BSA-Au-NCs, and (B) sequestered Hg ions reduced by NaBH₄.

FIG. 11 shows a representative TEM image of BSA-Au-NCs in the presence of Hg²⁺ ions.

FIG. 12 shows (A) a schematic of BSA-Au-NCs conjugated to polystyrene beads, and (B) a representative fluorescence image of BSA-Au-NCs conjugated to polystyrene beads.

FIG. 13 shows (A) photographs under UV light, and (B) relative fluorescence (I/I₀) at λₑₓ=470 nm of aqueous BSA-Au-NCs solutions (20 mM) in the presence of 50 mM of various metal ions.

FIG. 14 shows (A) photoemission spectra (λₑₓ=470 nm) of BSA-Au-NCs (20 nM) in the presence of different Hg²⁺ concentrations, and (B) relative fluorescence (I/I₀) of BSA-Au-NCs as a function of Hg²⁺ concentration.

FIG. 14C shows the linear detection range for 1-20 nM of Hg²⁺.

FIG. 15A shows photographs of the test strips with BSA-Au-NCs under UV light after the test strips have been dipped in solutions of 50 mM of various metal ions.

FIG. 15B shows photographs (under UV light) of test strips that have been dipped in solutions of Hg²⁺.

FIG. 16 shows the photoemission (λₑₓ=470 nm) spectra of aqueous solution of Au-NCs synthesized using (i) BSA, (ii) human serum albumin, and (iii) lysozyme.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention generally relates to methods, compositions, and articles comprising gold nanoclusters. In some cases, the gold nanoclusters are fluorescent and emit red energy with high quantum yields. The gold nanoclusters may be stabilized, for example, by a protein or stabilizing agent, as described herein. Some aspects of the invention relate to applications comprising the gold nanoclusters, for example, for the detection of mercury.

In some embodiments, a gold nanocluster comprises a plurality of gold atoms. The term “nanocluster,” as used herein, is given its ordinary meaning in the art and refers to a cluster comprising several to tens of metals atoms. In some cases, a nanocluster may comprise about between about 2 and about 30 associated gold atoms. In a particular case, a nanocluster comprises about 25 gold atoms. Those of ordinary skill in the art will be aware of methods to determine the approximate number of metal atoms that a nanocluster comprises (e.g., mass spectroscopy). In some cases, a nanocluster may comprise at least one gold atom in an oxidation state greater than zero (e.g., Au⁺, Au⁺³). The presence of at least one gold atom in an oxidation state greater than zero may be an important feature in the application of gold nanoclusters for the detection of mercuric ions, as described herein.

In some embodiments, gold nanoclusters of the present invention may be luminescent. A luminescent material refers to a material that can absorb a quantum of electromagnetic radiation to cause the material to achieve an excited state structure and, in some cases, emit radiation. The emitted radiation may be luminescence, in which “luminescence” is defined as an emission of ultraviolet or visible radiation. Specific types of luminescence include “fluorescence” in which a time interval between absorption and emission of visible radiation ranges from 10⁻¹² to 10⁻⁷ seconds. In some cases, upon exposure to a light source, gold nanoclusters of the present invention may emit fluorescent energy. The emitted fluorescent energy can be detected using methods known to those of ordinary skill in the art. In some cases, the intensity and/or wavelength of the emitted fluorescent energy may provide information about a sample being analyzed, as described herein.

In some embodiments, a gold nanocluster may emit light and/or have a λₘₐₓ emission (e.g., the wavelength of maximum emission) at a wavelength between about 700 and about 630 nm wavelength, between about 680 and about 640 nm, between about 675 and about 650 nm, or about 640 nm, about 650 nm, about 660 nm, about 670 nm, about 680 nm, about 690 nm, or the light. That is, in some embodiments, the gold nanoclusters may emit red energy and/or appear red under UV-light. In some cases, however, the nanocluster may emit light and/or have a λₘₐₓ emission in the near-IR region (e.g., between about 700 nm and about 1400 nm) or other wavelength regions of visible light (e.g., between about 400 nm and about 630 nm). Those of ordinary skill in the art will be aware of methods and techniques for determining the emitted light and/or λₘₐₓ emission of a plurality of gold nanoclusters. For example, the gold nanoclusters may be analyzed using fluorescence spectroscopy. In such analysis, the gold nanoclusters are exposed to a light source (e.g., ultraviolet light), the light causing electrons in certain molecules to be excited, and thereby emitting light of a lower energy (e.g., visible light).

In some embodiments, the quantum yield of a composition comprising gold nanoclusters may be determined. Quantum yield is the ratio of the photons absorbed by the composition to the photons emitted through fluorescence by the composition. In some embodiments, the composition comprising gold nanoclusters may emit energy and/or have a λₘₐₓ emission with a quantum yield of at least about 1%, at least about 2%, at least about 3%, at least about 4%, at least about 5%, at least about 6%, at least about 7%, at least about 8%, at least about 9%, at least about 10%, or more. In some cases, the quantum yield is about 4%, about 5%, about 6%, about 7%, about 8%, about 9%, about 10%, or between about 3% and about 10%, between about 4% and about 9%, or between about 5% and about 8%. Those of ordinary skill in the art will be aware of methods to determine the quantum yield of a composition. In some embodiments, the gold nanoclusters may emit fluorescence (or have a λₘₐₓ emission) at a wavelength between about 630 nm and about 700 nm with a quantum yield of at least 1%, or any other combination of the values described herein.

In some cases, nanoclusters may have an average diameter between about 0.1 nm and about 2 nm, between about 0.1 and about 1 nm, between about 0.1 and about 0.5 nm, between about 0.5 and about 1 nm, or the like. In some instances, the nanoclusters may have an average diameter of less than about 2 nm, less than about 1.5 nm, less than about 1 nm, less than about 0.5 nm, less than about 0.1 nm, or the like. The “average diameter” of a population of nanoclusters, as used herein, is the arithmetic average of the diameters of the nanoclusters. Those of ordinary skill in the art will be aware of methods and techniques to determine the average diameter of a population of nanoclusters, for example, using laser light scattering, dynamic light scattering (or photon correlation spectroscopy), transmission electron microscopy (TEM), etc.

In some embodiments, the nanoclusters may be polydisperse, substantially monodisperse, or monodisperse (e.g., having a homogenous distribution of diameters). A plurality of nanoclusters is substantially monodisperse in instances where the nanoclusters have a distribution of diameters such that no more than about 10%, about 5%, about 4%, about 3%, about 2%, about 1%, or less, of the droplets have a diameter greater than or less than about 20%, about 30%, about 50%, about 75%, about 80%, about 90%, about 95%, about 99%, or more, of the average diameter of all of the nanoclusters. In some embodiments, the nanoclusters are substantially spherical. In other embodiments, however, the nanoclusters may comprise a variety of shapes including spheres, triangular prisms, cubes, plates (e.g., triangle, square, round, rectangle plates), or the like.

In some embodiments, a gold nanocluster may be stabilized, for example, by association with a protein and/or a stabilizing agent, thereby forming a composition comprising gold nanoclusters and protein and/or stabilizing agent. In some cases, the protein may also assist in the formation of the gold nanocluster, as described herein. The association may comprise, for example, formation of at least one interaction between the gold nanocluster and the protein or stabilizing agent (e.g., between a residue in the protein and a gold atom or ion). In some cases, the interaction may be an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), Van der Waals interactions, and the like. In some embodiments, the interaction is not a covalent bond. Methods for synthesizing stabilized gold nanoclusters and for determining suitable proteins or stabilizing agents are described herein.

In some embodiments, the invention provides methods for synthesizing gold nanoclusters. In some cases, a method comprises forming a reaction mixture comprising a protein and a gold atom precursor, followed by adjusting the pH of the reaction mixture. The reaction mixture may be maintained at a suitable temperature for a sufficient period of time to form a plurality of gold nanoclusters, as described herein. The gold nanoclusters formed may be characterized by one or more properties as described herein (e.g., wavelength of emitted fluorescent light, quantum yield, average diameter, etc.).

Without wishing to be bound by theory, the presence of a protein may assist in the formation of a gold nanocluster. As an example, a protein molecule may sequester a plurality of gold ions (e.g., by association of a gold ion and a residue comprised in the protein such as tyrosine), thereby entrapping a plurality of gold ions within the protein. The protein may then reduce the gold ions to molecular gold atoms, and the close proximity of the gold atoms to each other (e.g., because the gold atoms are entrapped within the protein), may allow for the formation of a gold nanoclusters. In some instances, because each protein may likely associate with the same number of gold ions, the plurality of gold nanoclusters formed may be substantially monodisperse or monodisperse. In some embodiments, at least one protein (e.g., 1, 2, 3, 4, etc.) molecule may remain associated with a gold nanocluster following formation of the gold nanoclusters (e.g., thereby forming a stabilized gold nanocluster). In some cases, at least some of the at least one protein may be replaced with a stabilizing agent, as described herein.

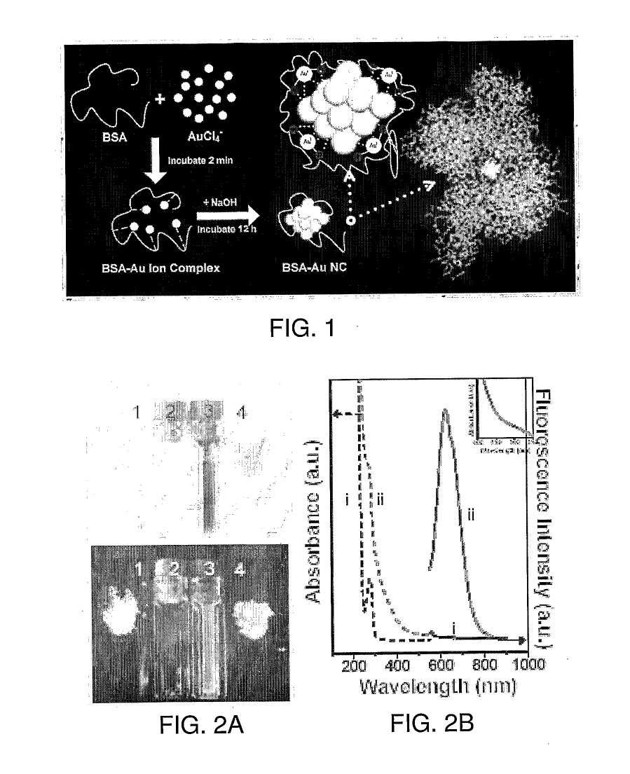

In a specific example, a solution comprising a gold atom precursor (e.g., comprising Au(III) ions) may be added to a solution comprising bovine serum albumin (BSA), forming a reaction mixture. The BSA molecules, in this embodiment, may sequester the gold ions and entrapped them (e.g., see FIG. 1). The reduction ability of BSA molecules may be activated by adjusting the pH of reaction mixture to be greater than about 11. The entrapped gold ions may be reduced to form gold nanoclusters, wherein the gold nanoclusters are stabilized by BSA molecules.

In some cases, a reaction mixture may be formed comprising a protein and a gold atom precursor. A solution of protein may be added to a solution of a gold atom precursor, or a solution of a gold atom precursor may be added to a solution of a protein. In some cases, the protein and gold atom precursor may be mixed as solids, followed by addition of a solvent. The solutions may be formed in any suitable solvent (e.g., water) which does not interfere with the reaction. The solutions may have a molarity of between about 0.1 M and about 10 M, between about 0.5 M and about 5 M, between about 0.5M and about 2M, or about 1M, about 2 M, about 3 M, about 4 M, or the like.

In some embodiments, the ratio of molecules of gold atom precursor to molecules of a protein is an important feature of the method that allows for the formation of nanoclusters as compared to nanoparticles. Without wishing to be bound by theory, it is postulated that the ratio is an important feature because it affects the number and aggregation of the gold atom precursor molecules to protein molecules (e.g., see results shown in Table 1).

Methods for determining a suitable ratio of molecules of gold atom precursor to molecules of a protein will now be described in more detail. In some embodiments, the appropriate ratio of molecules of gold atom precursor to molecules of a protein may be determined by determining the ratio of cysteine and tyrosine residues in the protein. In some embodiments, the ratio of cysteine and tyrosine residues comprised in the protein to the number of gold atoms precursor is about between about 1:1 and about 50:1, between about 1:1 and about 25:1, between about 5:1 and about 15:1, or any range therein. In a particular embodiment, the ratio is about 10:1. From the ratio of cysteine and tyrosine residues, the ratio of molecules of gold atom precursor to molecules of protein may be determined. For example, if the ratio of cysteine to tyrosine residues to gold atom precursors is selected to be 10:1, and the protein comprises 50 cysteine and tyrosine residues, the ratio of molecules of gold atom precursor to protein is about 5:1. In some cases, the ratio of molecules of gold atom precursor to molecules of protein is at least about 3:1, at least about 5:1, at least about 6:1, at least about 7:1, at least about 8:1, at least about 9:1, at least about 10:1, at least about 12:1, at least about 15:1, at least about 20:1 or greater. In some cases, the ratio is between about 5:1 and about 20:1, between about 8:1 and about 15:1, and the like.

Suitable proteins for use with the invention include proteins which comprise at plurality of (e.g., at least about 5, 10, 15, 20, 30, 40, 50, etc.) cysteine and/or tyrosine residues. Non-limiting examples of proteins include bovine serum albumin (BSA), human serum albumin, lysozyme, and the like.

A gold atom precursor, as used herein, refers to a precursor material that comprises gold in an oxidation state greater than zero (e.g., Au⁺, Au⁺³) and is capable of being reduced (e.g., by the protein) to form gold atoms. Those of ordinary skill in the art will be aware of appropriate gold atom precursors, for example, HAuCl₄, AuCl₃, and AuBr₃. In some cases, the gold atom precursor may be hydrated (e.g., comprises water).

Following forming a reaction mixture comprising a gold atom precursor and a protein, the pH of the reaction mixture may be adjusted, for example, by addition of a base to the reaction mixture. The base may be added immediately following or about 1 minute, about 2 minutes, about 3 minutes, about 5 minutes, about 10 minutes, or the like, after formation of the reaction mixture. The base may be any suitable base (e.g., NaOH) and may be added at any appropriate molarity (e.g., about 0.1 M, about 0.5 M, about 1 M, about 2 M) and amount to adjust the pH as desired. In some cases, the amount of base added may be such that the pH of the reaction mixture is adjusted to be at least about 10.5, at least about 11, at least about 11.5, at least about 12, at least about 13, or greater. In some cases, the pH of the reaction mixture may be between about 11 and about 14, between about 12 and about 14, or the like. Without wishing to be bound by theory, the pH of the reaction mixture may be an important feature of the invention, in some embodiments, because the pH of the reaction mixture affects the protonation or deprotonation of residues comprised in the protein (e.g., carboxyl group in aspartic and glutamic acid residues, thiol groups in cysteine, amine groups in lysine, etc.), thereby affecting the structure and reactivity of the protein (e.g., see results shown in Table 1).

Following adjustment of the pH of the reaction mixture to a selected level, the reaction mixture may be maintained at a suitable temperature for a sufficient period of time to form a plurality of gold nanoclusters. The reaction mixture may be agitated during this period of time (e.g., stirred, shaken). Those of ordinary skill in the art will be able to determine appropriate reaction temperatures and reaction times. For example, the temperature may be selected such that decomposition of deactivation of the protein does not occur. As another example, the temperature of the reaction may be selected such that the reaction proceeds within a reasonable amount of time (e.g., less than about 48 hours, about 24 hours, about 12 hours, etc.). In some cases, the reaction may be carried out until at least about 80%, at least about 85%, at least about 90%, at least about 95%, at least about 99%, or more, of the limiting reactant has been consumed. The progress of the reaction may be determined using methods and/or techniques known to those of ordinary skill in the art (e.g., photoemission spectrum, nuclear magnetic resonance, etc.).

In some embodiments, the reaction mixture may be maintained at, above, or below ambient temperature. In some cases, the reaction may be maintained at temperatures greater than ambient temperature, for example, at about 30° C., at about 35° C., at about 37° C., at about 40° C., at about 50° C., at about 60° C., at about 80° C., at about 100° C., or higher. In some cases, the reaction may be carried out between about 30° C. and about 40° C., between about 25° C. and about 40° C., between about 25° C. and about 50° C., between about 30° C. and about 100° C., or the like.

The reaction mixture may be maintained at a suitable temperature for between about 0 and 48 hours, between about 2 and about 24 hours, between about 4 and about 18 hour, between about 8 and about 12 hours, or about 1 hour, about 2 hours, about 4 hours, about 8 hour, about 12 hours, about 18 hours, about 24 hours, about 36 hours, or about 48 hours, or more.

In some embodiments, following formation of a gold nanocluster associated with at least one protein molecule, one or more of the at least one protein molecule may be replaced with a stabilizing agent. In some cases, essentially all of the protein molecules may be replaced by stabilizing agent. In some embodiments, a plurality of molecules of stabilizing agent may be provided to a solution comprising protein-stabilized gold nanoclusters, wherein the stabilizing agent has a greater affinity for the gold nanoclusters as compared to the protein. Thus, at least a portion of the protein molecules associated with each gold nanocluster may be displaced by at least one molecule of stabilizing agent. In some cases, the at least one stabilizing agent may remain associated with the gold nanocluster following displacement of the protein. For example, in some embodiments, protein molecules may be extracted using a chemical capping agent such as cysteine or glutathione. Following association of the stabilizing agent with the gold nanoclusters, the protein molecules may be separated from the gold nanoclusters stabilizing by a stabilizing agent, for example, by filtering, washing, and/or centrifuging.

The nanoclusters may be stored for any period of time or used immediately in one of the applications discussed herein. The nanoclusters may be stored for at least about 1 day, at least about 2 days, at least about 5 days, at least about 10 days, at least about 1 month, at least about 3 months, at least about 6 months or at least about 1 year, with no more than 10% loss in performance per month of storage, or no more than 5%, or even 2%, loss in performance per month of storage. Nanoclusters as described herein may be stored under varying conditions. In some instances, the nanoclusters may be stored in ambient conditions and/or under an atmosphere of air. In other instances, the nanoclusters may be stored under vacuum. In yet other instances, the nanoclusters may be freeze-dried.

The gold nanoclusters as described herein may be comprised in a variety of systems/devices and/or may be used in a variety of methods for specific applications. For example, the gold nanoclusters may be used in electrical or chemical sensing devices, wherein the devices may be used to qualitatively and/or quantitatively determine a chemical species in a target environment. That is, the gold nanoclusters may interact with the chemical species such that a change in a property of the gold nanoclusters may be determined to determine the presence, absence, and/or amount of a species present in the samples. As another example, the gold nanoclusters may also be employed for catalysis and/or in biological applications.

In some embodiments, the present invention provides methods and/or systems to qualitatively and/or quantitatively determine mercuric ions (Hg⁺²) in a sample. Mercury is a widespread pollutant and Hg⁺² is a caustic and carcinogenic material with high cellular toxicity. Methods of detecting of Hg⁺² are particularly useful for the analysis of environmental samples. In some cases, a property (e.g., fluorescence) of a plurality of gold nanoclusters may be determined prior to and following exposure to a sample suspected of containing mercuric ions. The change in the property may be determined, thereby determining whether the analyte is present in the sample, either quantitatively (e.g., by comparison to a calibration cure) or qualitatively (e.g., by an increase or decrease of the property).

In some embodiments, the presence of mercuric ions (Hg⁺²) may be determined qualitatively by on/off analysis of a property of a plurality of gold nanoclusters. In some cases, the detection mechanism may be a “turn-off” detection mechanism, wherein, in the absence of mercuric ions, the plurality of gold nanoclusters may produce a fluorescence emission (or other measurable property). In the presence of mercuric ions, the plurality of gold nanoclusters may interact with at least one mercuric ion and a quenched state or dark state may occur where substantially reduced or no fluorescence emission (or other measurable property) is observed.

In some embodiments, a method of detecting mercuric ions comprises providing a plurality of gold nanocluster (e.g., as described herein) and determining a first fluorescent intensity (or other measurable property). The plurality of gold nanoclusters may then be exposed to a sample containing or suspected of containing mercuric ions and a second fluorescent intensity may be determined. The presence, absence, and/or concentration of mercuric ions in the sample may be determined by determining a difference between the first and the second fluorescent (or other measurable property). In some embodiments, the difference between a first and second fluorescence intensity may be determined as a relative fluorescence (e.g., second fluorescent intensity divided by the first fluorescent intensity). The relative fluorescence may be compared to a calibration curve to determine the concentration of mercuric ions in the sample.

Those of ordinary skill in the art will be aware of methods and techniques for determining the fluorescence of a material (e.g., a composition comprising gold nanoclusters). In some embodiments, a material may be excited by light of a first wavelength, and the material may emit energy at a second wavelength of lower energy (e.g., longer wavelength). In some cases, the materials and composition as described herein may be exposed to light having a wavelength of less than about 300 nm, between about 300 and about 500 nm, between about 400 and about 500 nm, or at about 420 nm, about 430 nm, about 440 nm about 450 nm, about 460 nm about 470 nm, about 480 nm, about 490 nm, or the like. In a particular embodiment, the light has a wavelength of about 470 nm. The composition may emit energy having a wavelength as described herein (e.g., between about 630 nm and about 700 nm).

In some cases, the method may comprise providing a composition comprising a plurality of gold nanoclusters and a protein and/or stabilizing agent, exposing the composition to a sample suspected of containing mercuric ions, and determining whether the sample comprises mercuric ions (e.g., by determining a change in at least one property of the composition).

The methods of the present invention may allow for the detection of mercuric ions in a sample at low concentration levels. Recent theoretical studies suggest that dispersion forces between closed shell metal atoms are specific and strong, and greatly magnified by relativistic effects, particularly when these interactions involve heavy ions such as Hg²⁺ (4f¹⁴5d¹⁰) and Au⁺ (4f¹⁴5d¹⁰). Without wishing to be bound by theory, the surface of the Au-NCs as described herein are believed to comprise a small amount of Au⁺, thereby allowing for strong and specific interactions with Hg²⁺, providing low limits of detection. In some embodiments, the methods described herein may have a limit of detection of mercuric ions in a sample of less than about 50 nM, less than about 25 nM, less than about 10 nM, less than about 5 nM, less than about 1 nM, less than about 0.5 nM, less than about 0.1 nM, or about 10 nM, about 5 nM, about 1 nM, about 0.5 nM, about 0.1 nM, or the like.

In some cases, methods and articles for detecting mercuric ions may be specific for mercuric ions. That is, the methods and articles may specifically detect mercuric ions over other metals ions such as Ag⁺, Cu²⁺, Zn²⁺, Mg²⁺, K⁺, Na⁺, Ni²⁺, Mn²⁺, Fe³⁺, Cd²⁺, Pt⁴⁺, Pd²⁺, Co²⁺, Pb²⁺ and Ca²⁺ ions. The specificity is advantageous in instances where the sample is taken from an environmental source (e.g., in instances where the sample is likely to contain other metal ions). In some cases, the change in fluorescence intensity (or other property) of the gold nanoclusters or composition is less than about 30%, less than about 20%, less than about 15%, less than about 10%, less than about 5%, less than about 3%, less than about 1%, etc., upon exposure to at least metal ion other than Hg⁺². In addition, methods and articles for detecting mercuric ions may be robust towards various anions which may be contain in a sample (e.g., Cl⁻, NO³⁻, SO₄²⁻, PO₄³⁻, and buffers (e.g., 2-(4-(2-hydroxyethyl)-1-piperazinyl)ethanesulfonic acid)).

In some embodiments, articles may be provided for determining the presence, absence, and/or concentration of mercuric ions in a sample. In some cases, the article may comprise a substrate and a composition, the composition associated with the substrate. The composition may comprise gold nanoclusters and a protein or stabilizing agent (e.g., as described herein).

In some embodiments, the article may be a test strip, wherein the strip may be exposed to a solution suspected of comprising mercuric ions. The test strip may comprise a composition (e.g., comprising gold nanoclusters and protein or stabilizing agent) which may have a change in fluorescence emission (or other property) upon exposure to mercuric ions. In some embodiments, the change in the fluorescence emission (or other property) may determine quantitatively and/or qualitatively whether mercuric ions are present in the sample (e.g., as described herein). The test strip may be any suitable size and/or shape (e.g., square, rectangle, circle, etc.). In some cases, the size of the test strip may be such that it can fit into the mouth of commonly used lab glassware (e.g., test tube).

In some cases, a kit may be provided comprising at least one test strip for determining the presence, absence, and/or concentration of mercuric ions in a sample and a color (or other property) reference. In some cases, the colors provided on the color reference may be used to compare the color of the test strip following exposure to a sample suspected of containing or containing mercuric ions. In some cases, the colors of the color reference may be used to compare the fluorescent color of the test strip (e.g., the color of the test strip observed under LTV light). Following exposure of the test strip to a sample containing or suspected of containing mercuric ions, the color of the test strip may be compared with the color reference to determine the presence or absence of mercuric ions, and/or determine the approximately concentration of mercuric ions in the sample. For example, in instances where the test strip functions in qualitatively, the color reference may show the color of the test strip upon exposure to a sample that does not comprise mercuric ions. Thus, if following exposure to a sample, the test strip has a color which differs from the color reference, the sample comprises mercury. In instances where the test strip function in quantitatively, the color reference may show a plurality of colors, each color relating to an approximate concentration of mercuric ions in a sample. Thus, following exposure to a sample, the color of the test strip may be compared and matched to the closest color on the color reference, thereby indicating the approximate concentration of mercuric ions in the sample. Those of ordinary skill in the art will be aware of methods and techniques to determine the appropriate color(s) for the color reference (e.g., by exposing test strips to various known concentrations of samples comprising mercuric ions). The kit may additional comprise instructions for use. The color reference may be displayed completely separate from the test strip or may be associated with the test strip.

The composition may be associated with any suitable substrate to provide a test strip according to the invention. In some embodiments, the substrate material may comprise a material which is capable of associating with the protein or stabilizing agent associated with the gold nanoclusters or comprised in the composition. Non-limiting examples of substrates include cellulosic and non-cellulosic materials such as, for example, nitrocellulose, paper, natural or synthetic fibers, threads and yarns made from materials such as cotton, rayon, hemp, jute, bamboo fibers, cellulose acetate, carboxymethylated solvent-spun cellulose fibers, or combinations thereof. In some embodiments, the substrate may comprise a polymer, such as polyester, polyamide, polyacrylamide, polyacetate, etc., or combination thereof. The substrate may be porous or nonporous. The composition may be coated onto a surface of the substrate or impregnated into it, for example. The substrate may be flexible and/or rigid.

In preparing a test strip of the invention, a composition may be applied to a suitable substrate using techniques known to those of ordinary skill in the art. In embodiments of the invention, the preparation of a test strip includes preparing a coatable liquid composition that can be applied to the substrate. In general, the liquid composition is prepared by adding a plurality of BSA-associated gold nanoclusters to a solvent. The substrate may be dried prior to use (e.g., at ambient temperatures, at elevated temperatures, under vacuum). In some embodiments, additional components may be present (e.g., surfactant, binder, etc.).

A sample may be obtained from any suitable source. In some embodiments, the sample may include chemical samples, water samples, extracts, environmental samples (e.g., from an environmental source), food products, etc. In some embodiments, the sample may contain or be suspected of containing mercuric ions. The sample can be used directly as obtained from the source or may be pretreatment to modify at least one characteristic of the sample. Methods of pretreatment can involve filtration, distillation, concentration, inactivation of interfering components, and/or the addition of reagents. In some embodiments, the sample may be diluted or concentrated (e.g., in instances where the concentration of mercuric ions is too high to be determined by simple comparison with a calibration curve or color reference).

The following reference is herein incorporated by reference: U.S. Provisional Patent Application Ser. No. 61/129,994, filed Aug. 5, 2008, entitled “Protein/peptide-mediated synthesis of highly fluorescent metal nanoclusters,” by Ying, et al.

This and other aspects of the present invention will be further appreciated upon consideration of the following Examples, which are intended to illustrate certain particular embodiments of the invention but are not intended to limit its scope, as defined by the claims.

### Example 1

The following example describes the synthesis and properties of gold nanoclusters, according to some embodiments of the present invention.

Specifically, this example describes a simple, one-pot, “green” synthetic route, based on the biomineralization capability of a common commercially available protein, bovine serum albumin (BSA), for the preparation of Au-NCs at the physiological temperature (37° C.) with red emission (λₑₘ max=640 nm, quantum yield (QY) ˜6%). In this example, Au(III) ions are added to an aqueous BSA solution. The BSA molecules, in some cases, sequestered Au ions and entrapped them (see FIG. 1). The reduction ability of BSA molecules was activated by adjusting the pH of the reaction mixture to about 12; the entrapped ions underwent progressive reduction to form BSA conjugated gold nanoclusters (BSA-Au-NCs) in situ. The as-prepared BSA-Au-NCs comprised of about 25 gold atoms (as evident from matrix-assisted laser desorption/ionization-time of flight (MALDI-TOF) mass spectrometry), and were stabilized within BSA molecules as a BSA-Au-NCs (FIG. 1). The BSA-Au-NCs, in this embodiment, were water-soluble, buffer-stable, and stable even in solutions of harsh conditions, such as strong acids/bases and concentrated salts (1 M NaCl). The synthetic method could be easily scaled up to gram quantity with good batch-to-batch reproducibility, and the as-prepared BSA-Au-NCs could be stored as a powder after freeze drying. Besides the good biocompatibility and considerable environmental/cost advantages of this methodology, the BSA coating layer on Au-NCs also facilitated post-synthesis surface modifications with functional ligands.

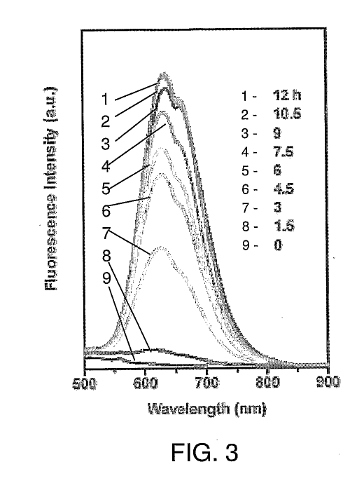

In a typical synthesis, aqueous HAuCl₄ solution (5 mL, 10 mM, 37° C.) was added to BSA solution (5 mL, 50 mg/mL, 37° C.) under vigorous stirring. After two minutes had elapsed, NaOH solution (0.5 mL, 1 M) was introduced, and the mixture was incubated at 37° C. for 12 h. The color of the solution changed from light yellow to light brown, and then to deep brown (FIG. 2A). Specifically, FIG. 2A shows photographs of BSA (1) powder and (2) aqueous solution, and BSA-Au-NCs (3) aqueous solution and (4) powder under (top) visible and (bottom) UV light. FIG. 2B shows the optical absorption (dash lines) and photoemission (solid lines, λₑₓ=470 nm) spectra of aqueous solution of (i) BSA and (ii) BSA-Au-NCs. The inset in FIG. 2B shows the weak absorption peak at about 480 nm for BSA-Au-NCs. The reaction was complete in about 12 hours, as confirmed by time-course measurements of the fluorescence evolution (FIG. 3). Specifically, FIG. 3 shows the time evolution of the photoemission spectrum (λₑₓ=470 nm) for the reaction mixture comprising HAuCl₄ and BSA at 37° C.

The deep brown solution of BSA-Au-NCs emitted an intense red fluorescence (FIG. 2A, bottom, 3) under UV light (about 365 nm). In contrast, the control BSA solution was pale yellow in color under visible light (FIG. 2A, top, 2), and emitted a peak blue fluorescence under UV light (FIG. 2A, bottom, 2), which was characteristic of the aromatic side groups in the amino acid residues (tryptophan, tyrosine (Tyr), and phenylalanine). The fluorescent Au-NCs showed absorption and emission peaks at about 480 nm and about 640 nm, respectively (FIG. 2B). The photoluminescence quantum yield (QY) was ˜6% (calibrated with fluorescein using a 470-nm laser).

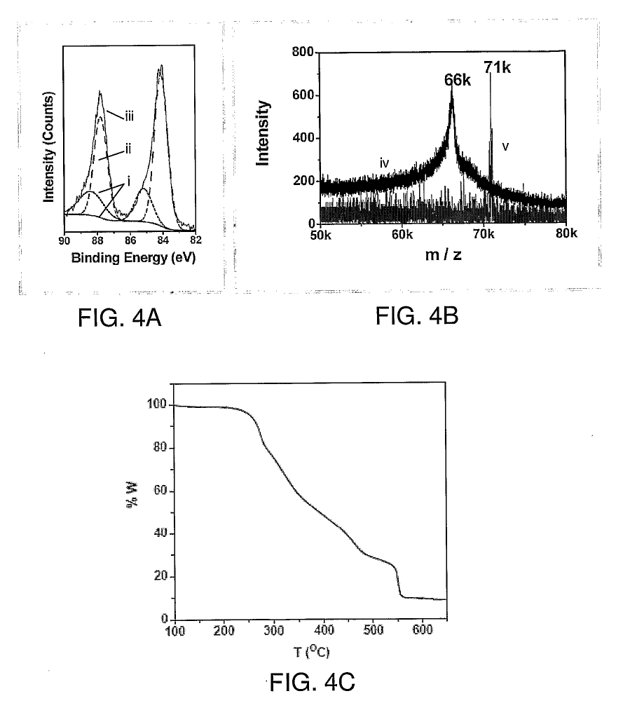

The oxidation state of the BSA-Au-NCs was determined by X-ray photoelectron spectroscopy (XPS). The Au 4f_{7/2} spectrum could be deconvoluted into two distinct components (lines ii and i, respectively in FIG. 4B) centered at binding energies of 84.0 and 85.1 eV, which could be assigned to Au(0) and Au(I), respectively. Specifically, FIG. 4 shows (A) XPS spectra of (iii) Au 4f in BSA-Au-NCs and (B) MALDI-TOF mass spectra of (iv) BSA and (v) BSA-Au-NCs.

The small amount of Au(I) (˜17%) present on the surface of the Au core helped to stabilize the nanoclusters, as described in a previous structural study of thiol-protected BSA-Au-NCs. The as-prepared BSA-Au-NCs might have a similar structure considering the presence of 35 thiol groups (from the 35 cysteine (Cys) residues) in a BSA monomer. The BSA-Au-NCs have a photoemission peak at about 640 nm, indicating the presence of Au₂₅ clusters based on the spherical Jellium model. The size of the as-prepared Au-NCs has been further confirmed by MALDI-TOF mass spectroscopy. The well-defined protein structure enabled analysis of the encapsulated nanocluster size with MALDI-TOF mass spectroscopy. The spectrum of the BSA without AuCl⁴⁻ showed one peak at m/z ˜66 kDa (FIG. 4B) which corresponded to the BSA molecular weight. The as-prepared BSA-Au-NCs showed a peak shift of ˜5 kDa, which could be contributed to the 25 gold atoms of the Au-NC. Thermal gravimetric (TGA) analysis of BSA-Au-NCs also provided supporting evidence (FIG. 4C). Specifically, FIG. 4C shows the TGA analysis of BSA-Au-NCs powder in air. Au-NCs with 25 atoms have been reported to be highly stable, and it corresponded to the most common magic cluster size with both shell closings and geometric contributions.

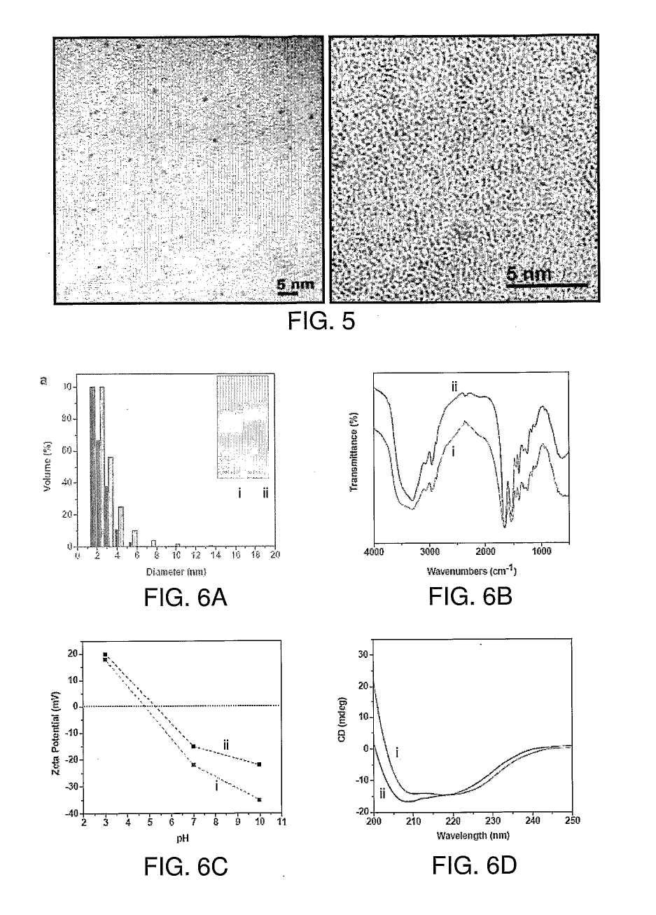

No obvious difference in fluorescence properties was observed for BSA-Au-NCs in solutions of a broad pH range (3-12), or in various buffer solutions (e.g., 50 mM of HEPES buffer (pH 7.65)), or in solutions with a high concentration of salts (e.g., 1 M of NaCl). The solvent could be removed by freeze drying, and the BSA-Au-NCs could be stored in the solid form (FIG. 2A, 4) for at least 2 months, and redispersed whenever needed. The BSA-Au-NCs may be been stabilized by a combination of Au—S bonding with the protein (e.g., via the 35 Cys residues in BSA), and the steric protection due to the bulkiness of the protein. The high stability of BSA-Au-NCs may greatly facilitate their use in in vitro and in vivo bioimaging applications. The encapsulation of Au-NCs (˜0.8 nm) (see representative TEM images in FIG. 5) in BSA molecules has little effect on the structure of the BSA scaffolds (see FIG. 6). Specifically, FIG. 6 shows (A) DLS histograms, (B) Fourier-transform infrared (FTIR) spectra, (C) zeta potential results, and (D) far-UV circular dichroism (CD) spectra of (i, or black) BSA and (ii, or grey) BSA-Au-NCs. The inset in (A) shows the electrophoresis data (under the UV light) of (ii) BSA (conjugated with FITC dye) and (i) BSA-Au-NCs.

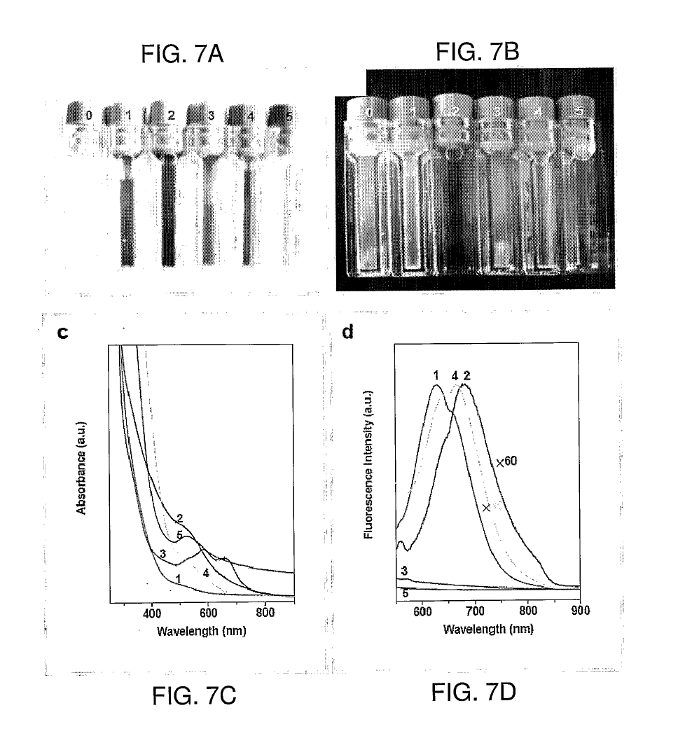

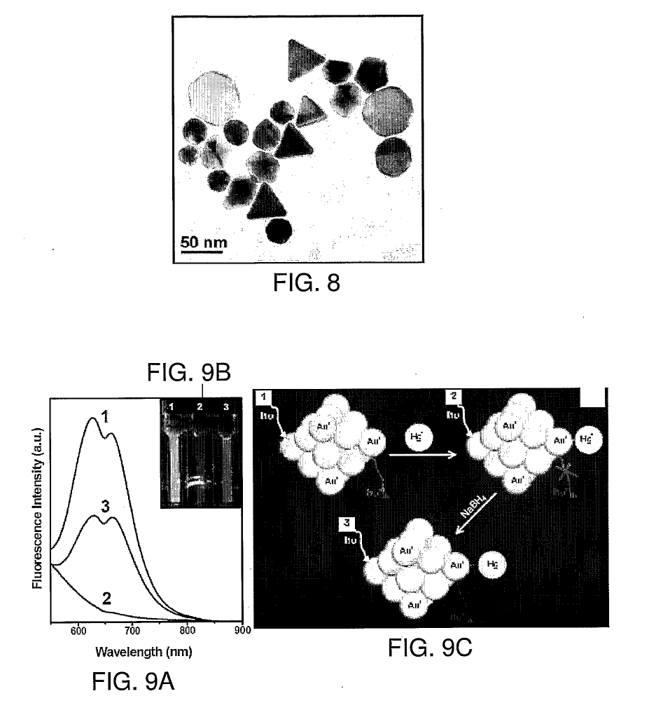

While it was not clear at the molecular level how BSA molecules “biomineralized” the fluorescent Au-NCs, there were several revealing experimental observations. Without wishing to be bound by theory, both the in situ reduction of encapsulated Au ions by the responsible residues of protein and the addition of NaOH were important, in some embodiments, for the formation of the BSA-Au-NCs. Control experiments were performed by adding an extraneous reductant, sodium borohydride (NaBH₄), in the same reaction solution as for the BSA-Au-NCs synthesis. The resulting BSA-Au-NCs emitted very weak red fluorescence (QY ˜0.1%, Table 1 and FIG. 7). Specifically, FIG. 7 shows photographs under (A) visible and (B) ultraviolet light, (C) optical absorption spectra, and (D) photoemission spectra (λex=470 nm) for (0) BSA, (1) BSA-Au-NCs synthesized under optimized conditions, (2) BSA-Au-NCs synthesized with NaBH₄, (3) BSA-Au-NCs synthesized without NaOH, (4) BSA-Au-NCs synthesized at 100° C., and (5) BSA-Au-NCs synthesized with a low BSA concentration (2.5 mg/mL). Recent studies have shown that Tyr or custom peptides containing Tyr residues can reduce Au(III) or Ag(I) ions through its phenolic groups; their reduction capability can be greatly improved by adjusting the reaction pH above the pKₐ of Tyr (˜10). The addition of NaOH was also necessary, without which only large nanoparticles (>20 nm) with irregular or plate-like morphologies were obtained (see FIG. 8, showing representative TEM image of BSA-Au-NCs synthesized without NaOH), and these nanoparticles showed no fluorescence. The reaction temperature was an important consideration in the synthesis of fluorescent Au-NCs with high QYs. The reaction was conducted at different temperatures (25, 37 and 100° C.), and Au-NCs formed very slowly at 25° C.; no clusters were detected even after 12 h of reaction. Reactions at the physiological temperature (37° C.) showed reasonable reduction kinetics. Reaction was completed within 12 h, and BSA-Au-NCs with high QYs (˜6%) were obtained. When the reaction temperature was increased to 100° C., the reaction rate was raised sharply. The reaction was completed within minutes; however, the as-prepared BSA-Au-NCs had relatively low QY (˜0.5%, see Table 1 and FIG. 7). The ratio of BSA concentration to Au precursors was important. At a fixed Au precursor concentration (5 mM), a high BSA concentration (10-25 mg/mL) (with a concentration of amino acid residues of ˜20-50 mM) was required for the effective protection of Au-NCs. Decreasing the BSA concentration to 2.5 mg/mL, while keeping Au precursor concentration constant (5 mM) produced large nanoparticles with no fluorescence (Table 1 and FIG. 7).

TABLE 1
Optical Properties of BSA-Au-NCs synthesized
under different reaction conditions.

| | λ_{abs} | λₑₘ | QY |
|---|---|---|---|
| Synthesis conditions | (max, nm) | (max, nm) | (%) |
| Optimized conditions (e.g., see | 480 | 640 | 6 |
| Example 2) | | | |
| With NaBH₄ | 530 | 683 | 0.1 |
| Without addition of NaOH | 520, 584, | — | — |
| | 667 | | |
| At 100° C. | 544 | 660 | 0.5 |
| At low BSA concentrations (2.5 mg/mL) | 530 | — | — |

In Table 1, QY of BSA-Au-NCs was determined by measuring the integrated fluorescence intensities of the BSA-Au-NCs and the reference (fluorescein solution in basic ethanol, QY=97%) under 470 nm excitation. The BSA-Au-NCs for spectral measurement were diluted with deionized water to yield an absorbance of ˜0.1 at 470 nm.

In summary, this example illustrated a new method for preparing Au-NCs with red emissions using a common protein to sequester and reduce Au precursors in situ. The as-prepared BSA-Au-NCs were stable both in solutions (aqueous or buffer) and in the solid form. The light-emitting Au-NCs comprised of about 25 gold atoms (Au₂₅). The experimental conditions have been optimized to derive BSA-Au-NCs with high QYs. The protocols and products are important not only because they provide a simple “green” method for the production of fluorescent BSA-Au-NCs, but also because they exemplify that the interactions of protein/peptide and Au ions (biomineralization or biomimetic mineralization) can be used towards the creation of protein-Au-NC.

### Example 2

The following example describes additional experimental information regarding the gold nanoclusters prepared and used in Example 1.

All chemicals were purchased from Sigma-Aldrich and used as-received. Ultrapure Millipore water (18.2 M) was used.

Synthesis of Red Fluorescent Au-NCs. All glassware was washed with aqua regia (HCl:HNO₃ volume ratio=3:1), and rinsed with ethanol and ultrapure water. In a typical experiment, aqueous HAuCl₄ solution (5 mL, 10 mM, 37° C.) was added to BSA solution (5 mL, 50 mg/mL, 37° C.) under vigorous stirring. NaOH solution (0.5 mL, 1 M) was introduced 2 min later, and the reaction was allowed to proceed under vigorous stirring at 37° C. for 12 h.

Materials Characterization. Absorption and photoemission spectra were obtained with an Agilent 8453 UV-visible spectrometer and a Jobin Yvon Horiba Fluorolog fluorescence spectrometer, respectively. DLS analyses of aqueous BSA-Au-NC and BSA solutions were performed with a BI-200SM laser light scattering system (Brookhaven Instruments Corporation). The elemental analysis was performed on an ELAN 9000/DRC ICP-MS system. The molecular weights of BSA and BSA-Au-NCs were analyzed with MALDI-TOF mass spectrometry on a Bruker Daltonics Autoflex II TOF/TOF system. Transmission electron microscopy (TEM) and XPS were performed on a FEI Tecnai TF-20 field-emission high-resolution transmission electron microscope at 200 kV, and on a VG ESCALAB MKII spectrometer, respectively. Narrow-scan XPS spectra of Au 4f core levels were deconvoluted by the XPSPEAK software (Version 4.1), using adventitious carbon to calibrate the binding energy of C1s (284.5 eV).

### Example 3

The following example describes the detection of mercuric ions (Hg⁺²) using gold nanoclusters, according to a non-limiting embodiment of the invention. Routine detection of mercuric ions (Hg²⁺) is an important aspect of environmental monitoring in aquatic ecosystems because of its deleterious effects on the environment and human health.

Without wishing to be bound by theory, recent theoretical studies suggest that dispersion forces between closed shell metal atoms are highly specific and strong, and greatly magnified by relativistic effects, particularly when these interactions involve heavy ions such as Hg²⁺ (4f¹⁴5d¹⁰) and Au⁺ (4f¹⁴5d¹⁰). The use of Hg²⁺—Au⁺ interactions is therefore attractive for a label-free approach in Hg²⁺ detection. As described in Example 1, gold nanoclusters (BSA-Au-NCs) were synthesized using a protein-templated method. The as prepared BSA-Au-NCs comprised of about 25 gold atoms (Au25), and emitted intense red fluorescence (λₑₘ max=640 nm). The surface of the cluster core is stabilized by a small amount of Au⁺ (˜17%), which may have strong and specific interactions with Hg²⁺. In this example, a technique for the detection of Hg²⁺, which relies on the metallophilic Hg²⁺—Au⁺ interactions to quench the fluorescence of BSA-Au-NCs is presented, as shown in FIG. 9. FIG. 9 shows (C) schematic of Hg²⁺ sensing based on the fluorescence quenching of Au-NCs resulting from high affinity metallophilic Hg²⁺—Au⁺ bonds, and (A) photoemission spectra (λₑₓ=470 nm) and (B) photographs under UV light of Au-NCs (20 mM) in the (1) absence and (2) presence of Hg²⁺ ions (50 mM). This one-step method is simple, fast, and has high selectivity and sensitivity. Moreover, it can be employed (as shown below) as a paper test strip to facilitate routine Hg²⁺ monitoring.

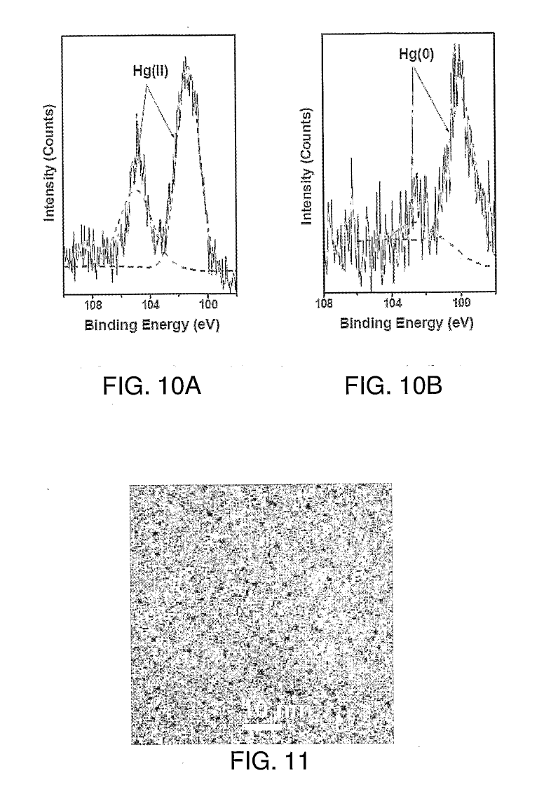

Fluorescent BSA-Au-NCs were synthesized and purified according to the procedure described in Example 4. Upon adding Hg²⁺ ions (50 mM) to the aqueous Au-NCs solution (˜20 mM), the red fluorescence of BSA-Au-NCs (FIG. 9B, 1) was completely quenched within seconds (FIG. 9B, 2), as evident also in the photoemission spectra (FIG. 9A). The fluorescence quenching of BSA-Au-NCs was due to the interaction of Hg²⁺ with Au⁺. The red fluorescence of BSA-Au-NCs could be partially recovered by adding a strong reductant (e.g., sodium borohydride) to BSA-Au-NCs solution in the presence of Hg²⁺ ions (FIGS. 9A and 9B, 3). Without wishing to be bound by theory, it is believed that sodium borohydride reduces Hg²⁺ to Hg⁰, and since the latter has a weaker binding energy with Au⁺, and thus, a lower quenching efficiency on fluorescent Au-NCs. The oxidation state of Hg was confirmed by X-ray photoelectron spectroscopy (XPS) (FIG. 10). Specifically, FIG. 10 shows XPS Hg 4f spectra of (A) Hg ions sequestered by BSA-Au-NCs, and (B) sequestered Hg ions reduced by NaBH₄.

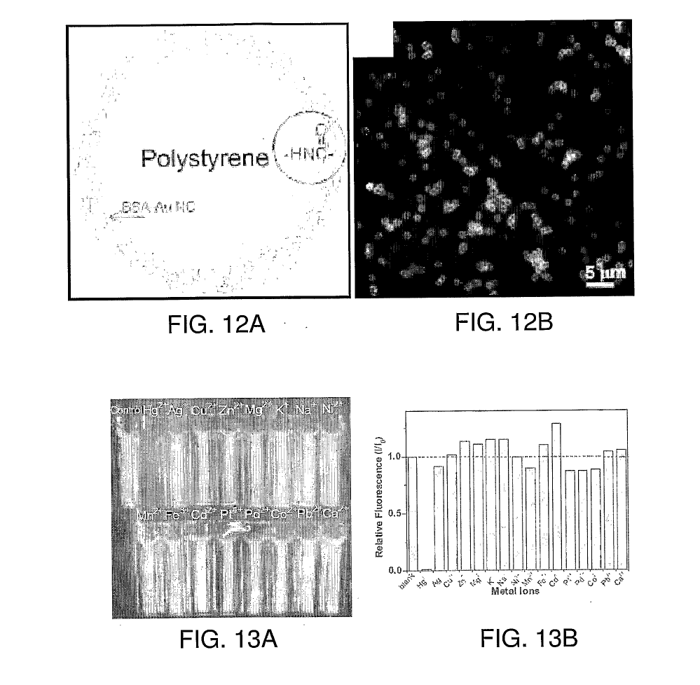

The addition of Hg²⁺ ions to BSA-Au-NCs solution has little effect on the size of BSA-Au-NCs (FIG. 11), which ruled out the effects of BSA-Au-NCs aggregation on the fluorescence quenching. FIG. 11 shows a representative TEM image of BSA-Au-NCs in the presence of Hg²⁺ ions, indicating a cluster size of 0.8 nm. Moreover, the aggregation of as prepared BSA-Au-NCs has negligible effects on the fluorescence of BSA-Au-NCs (FIG. 12). FIG. 12 shows (A) a schematic of BSA-Au-NCs conjugated to polystyrene beads (1 mm) through 1-ethyl-3-[3-dimethylaminopropyl]carbodiimide (EDC) method and (B) a representative fluorescence image of polystyrene-BSA-Au-NCs.

The high specificity of Hg²⁺—Au⁺ interactions provided the excellent selectivity of this method towards detecting Hg²⁺ over other environmentally relevant metal ions. FIG. 13A shows that the fluorescence of BSA-Au-NCs was not quenched by 50 M of Ag⁺, Cu²⁺, Zn²⁺, Mg²⁺, K⁺, Na⁺, Ni²⁺, Mn²⁺, Fe³⁺, Cd²⁺, Pt⁴⁺, Pd²⁺, Co²⁺, Pb²⁺ and Ca²⁺ ions. Only Hg²⁺ ions led to almost 100% quenching of BSA-Au-NCs fluorescence (FIG. 13B). This detection selectivity could be visualized with the naked eye (FIG. 13B). Specifically, FIG. 13 shows (A) photographs under UV light and (B) relative fluorescence (I/I₀) at λₑₓ=470 nm of aqueous Au-NCs solutions (20 mM) in the presence of 50 mM of various metal ions.

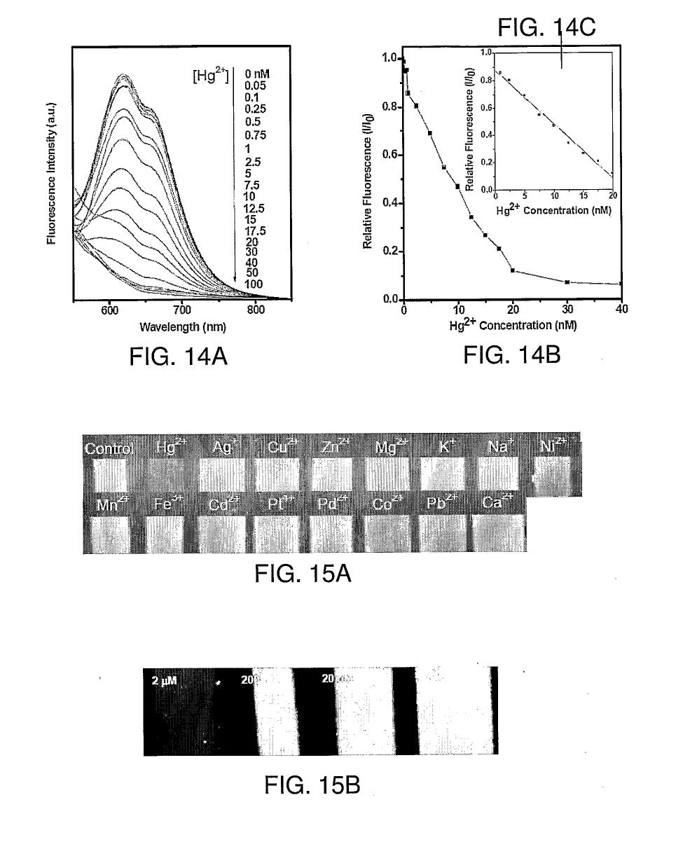

In addition, the as-prepared Au-NCs were robust towards various anions (e.g., Cl⁻, NO³⁻, SO₄²⁻, and PO₄³⁻) and buffers (e.g., 2-(4-(2-hydroxyethyl)-1-piperazinyl)ethanesulfonic acid (HEPES)), making this method suitable for examining samples from various environments. The strong binding energies of Hg²⁺ with Au⁺ also made this method highly sensitive. Theoretically, the fluorescence of BSA-Au-NCs could be quenched by one Hg²⁺ ion through interaction with one Au⁺ ion on the NC surface. To evaluate the sensitivity of the assay, different concentrations of Hg²⁺ (0.05-100 nM) were added to a series of solutions containing 20 nM of Au-NCs. As shown in FIG. 14, the fluorescence of the BSA-Au-NCs was reduced with increasing Hg²⁺ concentration. The fluorescence intensity of BSA-Au-NCs toward Hg²⁺ decreased linearly over the Hg²⁺ concentration range of 1-20 nM. Specifically, FIG. 14 shows (A) photoemission spectra (λₑₓ=470 nm) of BSA-Au-NCs (20 nM) in the presence of different Hg²⁺ concentrations, and (B) relative fluorescence (VW of BSA-Au-NCs as a function of Hg²⁺ concentration. FIG. 14C shows the linear detection range for 1-20 nM of Hg²⁺. The limit of detection (LOD) for Hg²⁺, at a signal-to-noise ratio of 3, was estimated to be 0.5 nM (0.1 ppb), which was much lower than the maximum level (2.0 ppb) of mercury in drinking water permitted by the United States Environmental Protection Agency (EPA).

The detection of Hg⁺² using the gold nanoclusters was extended to a paper test strip system. BSA-Au-NCs were dispersed on a nitrocellulose strip. They were encapsulated by BSA scaffolds, which could be entrapped in the nitrocellulose membrane. The non-binding BSA-Au-NCs were rinsed away with water. The selectivity of this paper test strip system for Hg²⁺ detection was evaluated by dipping the test strips in solutions of various metal ions at a concentration of 50 mM. Only the test strip dipped in Hg²⁺ ion solution was weak green in color (which was the background color of nitrocellulose membrane) under the LTV light (FIG. 15A). Specifically, FIG. 15A shows photographs of the test strips with BSA-Au-NCs under UV light after the test strips have been dipped in solutions of 50 mM of various metal ions. All other test strips emitted strong red fluorescence associated with the BSA-Au-NCs. The test strips also gave different colors (from green to purple) after they were dipped in Hg²⁺ ion solutions of various concentrations (2 mM (dark green), 200 nM (purple), 20 nM (purple-pink), and 2 nM (pink)), as shown in FIG. 15B. Specifically, FIG. 15B shows photographs (under UV light) of test strips that have been dipped in solutions of Hg²⁺. Thus, they could be used to rapidly estimate the Hg²⁺ ion concentrations visually.

This example illustrates, according to non-limiting embodiment, a new simple method to detect Hg²⁺ ions using fluorescent BSA-Au-NCs in aqueous media with very high selectivity and sensitivity. The sensing mechanism was based on the high affinity metallophilic Hg²⁺—Au⁺ interactions, which effectively quenched the fluorescence of BSA-Au-NCs. The BSA-Au-NCs showed a remarkably high selectivity for Hg²⁺ over other metal ions, and detected Hg²⁺ ions at concentrations as low as 0.5 nM. This process was notable as it involved green chemistry, and could be developed as a simple paper test strip system for the rapid routine monitoring of Hg²⁺ ions.

### Example 4

The following example describes additional experimental information regarding the gold nanoclusters prepared and used in Example 3.

All chemicals were purchased from Sigma-Aldrich and used as-received. Ultrapure Millipore water (18.2 MW) was used.

Synthesis of Red Fluorescent Au-NCs. All glassware was washed with aqua regia (HCl/HNO₃ volume ratio=3:1), and rinsed with ethanol and ultrapure water. In a typical experiment, aqueous HAuCl₄ solution (5 mL, 10 mM, 37° C.) was added to BSA solution (5 mL, 50 mg/mL, 37° C.) under vigorous stirring. NaOH solution (0.5 mL, 1 M) was introduced 2 min later, and the reaction was allowed to proceed under vigorous stirring at 37° C. for 12 h.

### Example 5

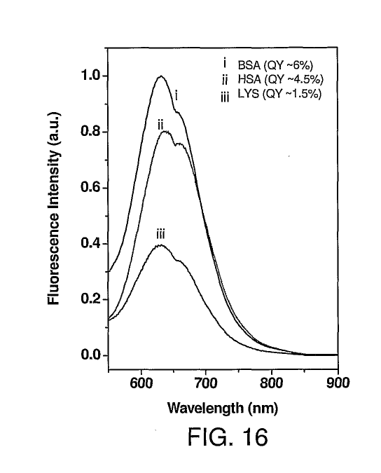

Using the procedure described in the Example 4, Au-NCs were synthesized using human serum albumin (HSA) or lysozyme (LYS) in place of BSA. The photoemission (λₑₓ=470 nm) spectra of aqueous solution of Au-NCs synthesized using (i) BSA, (ii) HSA, or (iii) LYS, are shown in FIG. 16

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A composition, comprising:
a plurality of gold nanoclusters; and
a protein or stabilizing agent,
wherein the gold nanoclusters are capable of emitting fluorescence at a wavelength between about 630 nm and about 700 nm with a quantum yield of at least 1%.

2. A method for forming a plurality of gold nanoclusters, comprising:
forming a reaction mixture comprising a plurality of molecules of gold atom precursor and plurality of molecules of protein, wherein the ratio of molecules of gold atom precursor to molecules of protein is at least about 5:1;
adjusting the pH of the reaction mixture to be greater than about 11; and
maintaining the reaction mixture at a suitable temperature for a sufficient period of time to form a plurality of gold nanoclusters stabilized by at least one protein molecule,
wherein the gold nanoclusters have an average diameter of less than about 2 nm.

3. A method of detecting mercuric ions, comprising:
providing a composition comprising a plurality of gold nanoclusters and a protein or a stabilizing agent;
exposing the composition to a sample suspected of containing mercuric ions; and
determining whether the sample comprises mercuric ions.

4. A method of detecting mercuric ions, comprising:
providing a plurality of gold nanoclusters, the gold nanoclusters having a first fluorescent intensity at a wavelength between about 630 nm and about 700 nm with a quantum yield of at least 1%;
exposing the nanoclusters to a sample suspected of containing mercuric ions and determining a change in the fluorescent intensity; and
determining whether the sample contains mercuric ions based upon the change in the fluorescent intensity.

5. A method of detecting mercuric ions, comprising:
providing a composition comprising a plurality of stabilized gold nanoclusters having the formula Au₂₅;
exposing the composition to a sample suspected of containing mercuric ions; and
determining whether the sample comprises mercuric ions.

6. An article for determining the presence or absence of mercuric ions in a sample, comprising:
a substrate; and
a composition associated with the substrate, wherein the composition comprises gold nano clusters and a protein or a stabilizing agent.

7. A composition, method, or article of any preceding claim, wherein a gold nanocluster comprises about 25 gold atoms.

8. A composition, method, or article of any preceding claim, wherein the protein is bovine serum albumin.

9. A composition, method, or article of any preceding claim, wherein the protein is human serum albumin.

10. A composition, method, or article of any preceding claim, wherein the protein is lysozyme.

11. A composition, method, or article of any preceding claim, wherein the gold nanoclusters have an average diameter of less than about 2 nm.

12. A composition, method, or article of any preceding claim, wherein the gold nanoclusters have an average diameter of less than about 1 nm.

13. A composition, method, or article of any preceding claim, wherein the gold nanoclusters are substantially monodisperse.

14. A composition, method, or article of any preceding claim, wherein the gold nanoclusters are capable of emitting fluorescence at a wavelength between about 630 nm and about 700 nm.

16. A composition, method, or article of any preceding claim, wherein the gold nanoclusters are capable of emitting fluorescence with a quantum yield of at least 1%.

17. A composition, method, or article of any preceding claim, wherein the gold nanoclusters are capable of emitting fluorescence with a quantum yield of at least 3%.

18. A composition, method, or article of any preceding claim, wherein the gold nanoclusters are capable of emitting fluorescence with a quantum yield of about 6%.

19. A method of any preceding claim, comprising heating the reaction mixture to at least 30° C. for at least 2 hours.

20. A method of any preceding claim, comprising heating the reaction mixture at about 37° C. for at least about 8 hours.

21. A method of any preceding claim, further comprising replacing one or more of the at least one protein molecule stabilizing the gold nanocluster with a stabilizing agent.

22. A composition, method, or article of any preceding claim, wherein the stabilizing agent is cysteine or glutathione.

23. A method or article of any preceding claim, wherein the limit of detection of mercuric ions is less than about 5 nM.

24. A method or article of any preceding claim, wherein the limit of detection of mercuric ions is less than about 1 nM.

25. A method or article of any preceding claim, wherein the limit of detection of mercuric ions is less than about 0.5 nM.

26. A method of any preceding claim, wherein determining whether a sample comprises mercuric ions comprises determining a change in fluorescence of the composition or gold nanoclusters.

27. A method of any preceding claim, wherein the change in fluorescence intensity of the gold nanoclusters or composition is less than 20% upon exposure to at least one of the metal ions selected from the group consisting of Ag⁺, Cu²⁺, Zn²⁺, Mg²⁺, K⁺, Na⁺, Ni²⁺, Mn²⁺, Fe³⁺, Cd²⁺, Pt⁴⁺, Pd²⁺, Co²⁺, Pb²⁺, or Ca²⁺.

28. A method of any preceding claim, further comprising determining a measure of the concentration of mercuric ions in the sample.

29. A method of any preceding claim, wherein the measure of the concentration of the mercuric ions in the sample is determine based upon a change in the fluorescence of the composition or gold nanoclusters.

30. A method of any preceding claim, wherein the sample is obtained from an environmental source.

31. An article of any preceding claim, wherein the substrate comprises nitrocellulose.

32. A method of any preceding claim, wherein the pH of the reaction mixture is adjusted to be greater than about 12.

33. A method of any preceding claim, wherein the pH of the reaction mixture is adjusted by providing a base to the reaction mixture.

34. A method of claim 33, wherein the base is NaOH.
